(19) United States
(12) Patent Application Publication
(10) Pub. No.: US 2024/0283859 A1
(43) Pub. Date: Aug. 22, 2024

(54) COMBINATION ELECTRONIC CASE AND WRITING SURFACE

(71) Applicant: Gustavo Barajas, Key Largo, FL (US)

(72) Inventor: Gustavo Barajas, Key Largo, FL (US)

(21) Appl. No.: 18/443,533

(22) Filed: Feb. 16, 2024

Related U.S. Application Data
(60) Provisional application No. 63/447,407, filed on Feb. 22, 2023.

(51) Int. Cl. H04M 1/21; H04M 1/02

(52) U.S. Cl. CPC H04M 1/21; H04M 1/0216; H04M 1/0274; H04M 1/0283

(57) ABSTRACT

A multifunctional case for handheld electronic devices that includes a protective housing that encloses a mobile phone or tablet to prevent the enclosed object from damage is disclosed. The case has a plurality of walls and a rear surface, designed to couple with a mobile phone. In some embodiments, the case features slots for accessing phone functionalities. The case includes a writing tool holder which can be in the form of a cylindrical loop for holding a writing tool, and a dry erase board or whiteboard on the back surface for writing and note-taking. A removable clear cover protects the dry erase board's contents. The case material is durable, shockproof, scratch-resistant, heat resistant, and waterproof, made from materials like polycarbonate, silicon, and Kevlar. Additionally, the case includes an integrated handle and an LCD writing pad on the back for additional functionality.

### CROSS-REFERENCE TO RELATED APPLICATION

The present application claims priority to, and the benefit of, U.S. Provisional Application No. 63/447,407, which was filed on Feb. 22, 2023, and is incorporated herein by reference in its entirety.

### FIELD OF THE INVENTION

The present invention generally relates to the field of protective cases for handheld electronic devices. More specifically, the present invention relates to a novel multifunctional case for handheld electronic devices. The case includes a protective housing that encloses a mobile phone or tablet to protect the enclosed object from physical damage. The case includes a writing tool holder for holding a writing tool, and a dry erase board or whiteboard on the back surface for writing and note-taking. A clear removable cover, protects the dry erase board's contents. Accordingly, the present disclosure makes specific reference thereto. Nonetheless, it is to be appreciated that aspects of the present invention are also equally applicable to other like applications, devices, and methods of manufacture.

### BACKGROUND

By way of background, people commonly make notes of important events, grocery lists, daily tasks, and to-do lists. Taking notes also helps process and understand information by summarizing and organizing the key points. Many people make notes as a valuable brainstorming tool for generating new ideas. Most people like making notes using a notepad/paper and a pen. Some people use their smartphones, tablets, and other similar devices for making notes.

However, often, individuals don't have access to traditional note-taking tools like pens and paper especially when they are on the go. Also, smartphones can run out of battery due to extensive use for other tasks. Using paper for making notes increases use of paper which is not eco-friendly. Use of paper for note-making is especially prevalent in colleges (i.e., school settings) and offices. Many people are not tech-savvy and are not comfortable using digital note applications on smartphones. People desire an easily accessible solution to make notes in a traditional manner without using paper while solving challenges of battery consumption of smartphones and other similar electronic devices.

Conventional phone cases and tablet cases provide protection to an electronic device but do not add any additional functionality. To provide a conventional note-making or taking tool, a regular case can be improved with the utility of a note-taking surface. The case can overcome the problems associated with conventional note-making process while ensuring the safety of the phone. Parents can also make use of a note-taking surface for doodling, drawing, and playing games on the surface to entertain children while at home, commuting, and more. However, the unavailability of paper can lead to frustration. The case with a note-taking surface such as a dry erase board can overcome the problems of entertaining children.

Therefore, there exists a long-felt need in the art for a hybrid phone or tablet case that is equipped with a note-taking surface such as a dry erase board. Additionally, there is a long-felt need in the art for a handheld electronic device case that allows users to make notes on the back of the case. Moreover, there is a long-felt need in the art for a phone or tablet case that includes a dry erase board enabling users to use a dry-tip marker to make notes or doodles. Further, there is a long-felt need in the art for an improved phone or tablet case that protects an electronic device from physical damage while enabling users to write down notes or create small doodles with a marker. Furthermore, there is a long-felt need in the art for an innovative phone case that provides a simple, user-friendly alternative for paper and smartphone for note-making. Also, there is a long-felt need in the art for a hybrid phone or tablet case that reduces use of paper and reduces dependency on smartphones/tablets for note-making. Finally, there is a long-felt need in the art for a multifunctional phone and tablet case that helps protect the phone against damage and offers a way to keep children entertained and to facilitate note-making.

The subject matter disclosed and claimed herein, in one embodiment thereof, comprises a multifunctional protective case for handheld electronic devices. The case features a protective housing to enclose an electronic device such as a mobile phone. A cylindrical loop for accommodating a writing tool, wherein the loop secures the tool using a friction fit and allows removal of the tool by applying sufficient force to overcome the friction fit. A dry erase board or whiteboard is adhered to or integral with the planar back surface of the housing and the dry erase board is used for writing, doodling, and making notes. A clear cover overlaps the dry erase board or whiteboard for protecting notes, doodles, drawings, etc., from being accidentally erased, wherein the clear cover is secured using fasteners and can be slid along the side walls for removable overlapping of the dry erase board or whiteboard.

In this manner, the multifunctional protective case of the present invention accomplishes all of the foregoing objectives and provides users with a hybrid phone or tablet case equipped with a dry erase board on the back surface thereof. The case allows users to apply a dry-tip marker to the dry erase board to make notes or doodles on the back of their electronic device, thereby eliminating the requirement of using paper. The case protects an enclosed device from damage. The multifunctional phone and tablet case helps protect the phone against damage and offers a way to keep children entertained and facilitate note-making.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a multifunctional case for handheld electronic devices. The case further comprising a protective housing designed to couple and enclose at least a portion of a mobile phone, said housing including a pair of side walls, a bottom wall, and a top wall extending perpendicularly from a planar rear surface. One or more slots disposed in at least one wall of the housing for enabling access to charging ports and other functionalities of the mobile phone. A cylindrical loop positioned on the outer surface of one of the side walls for accommodating a writing tool, wherein the loop secures the tool using a friction fit and allows removal of the tool by applying sufficient force to overcome the friction fit. A dry erase board or whiteboard is adhered to or integral with the planar back surface of the housing and the dry erase board is used for writing, doodling, and making notes.

In another aspect, a clear cover overlaps the dry erase board or whiteboard for protecting notes, doodles, drawings, etc., from being accidentally erased, wherein the clear cover is secured using fasteners and can be slid along the side walls for removable overlapping of the dry erase board or whiteboard.

In yet another embodiment, the material of the case being a combination of durability, shock absorption, scratch resistance, heat resistance, and waterproof properties, and made from one or more materials selected from a group consisting of polycarbonate, thermoplastic polyurethane, silicon, leather, carbon fiber, Kevlar, rubber, and metal.

In a further embodiment of the present invention, a mobile phone case is disclosed. The case includes a protective housing designed to enclose and secure a mobile phone, wherein the housing includes a top wall, a bottom wall, and a pair of side walls, each adhering respectively to the top edge, bottom edge, and side edges of the mobile phone. A dry erase board or whiteboard is positioned on the back surface of the case and is configured for writing, making notes, doodling, and other similar activities using a writing tool. A clear cover is designed to overlap the dry erase board or whiteboard, protecting the written content from accidental erasure, wherein the clear cover is configured to be removable or displaceable for cleaning and reusing the dry erase board or whiteboard.

In yet another aspect, the protective case includes an integrated handle for carrying an electronic device enclosed within the case, and an LCD writing pad is included on the back of the case for writing, doodling, making/taking notes, and more.

In yet another embodiment, a multifunctional protective case for tablets and similar devices, comprising a protective housing configured to enclose and protect a tablet, a plurality of walls adhered to the edges of the tablet, wherein at least one of the walls includes a cylindrical loop designed for securely and removably accommodating a writing utensil, a back wall of the case has an outer surface that includes a writing surface in the form of a dry erase board or whiteboard, wherein the writing surface is designed for receiving markings from the writing utensil. A clear, removable cover overlays the writing surface, wherein the cover is adapted to protect the markings on the writing surface from being erased and is removable to provide access to the writing surface for writing or erasing purposes.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1A illustrates a front perspective view of one potential embodiment of the multifunctional electronic device case of the present invention in accordance with the disclosed structure;

FIG. 1B illustrates a rear perspective view of the multifunctional electronic device case of FIG. 1A in accordance with the disclosed structure;

FIG. 2 illustrates a mobile phone enclosed in the multifunctional phone case of FIG. 1A in accordance with one embodiment of the present invention;

FIG. 3A illustrates a front perspective view of a tablet phone case of the present invention in accordance with the disclosed structure;

FIG. 3B illustrates a rear perspective view of the tablet phone case of the present invention in accordance with the disclosed structure;

FIG. 4 illustrates a rear view of yet another embodiment of the multipurpose protective case of the present invention in accordance with one embodiment of the present invention;

FIG. 5 illustrates a mobile phone enclosed in a multifunctional phone case in accordance with another embodiment of the present invention;

FIG. 6 illustrates a mobile phone enclosed in the multifunctional phone case of FIG. 5 in accordance with the present invention; and

FIG. 7 illustrates a mobile phone enclosed in a multifunctional phone case in accordance with yet still another embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a hybrid phone or tablet case that is equipped with a note-taking surface such as a dry erase board. Additionally, there is a long-felt need in the art for a handheld electronic device case that allows users to make or take notes on the back of the case. Moreover, there is a long-felt need in the art for a phone or tablet case that includes a dry erase board enabling users to use a dry-tip marker to make/take notes or doodles. Further, there is a long-felt need in the art for an improved phone or tablet case that protects an electronic device from physical damage while enabling users to write down notes or create small doodles with a marker. Furthermore, there is a long-felt need in the art for an innovative phone case that provides a simple, user-friendly alternative for paper and smartphone for note-making. Also, there is a long-felt need in the art for a hybrid phone or tablet case that reduces use of paper and reduces dependency on smartphone/tablets for note-making. Finally, there is a long-felt need in the art for a multifunctional phone and tablet case that helps protect the phone against damage and offers a way to keep children entertained and facilitate note-making.

The present invention, in one exemplary embodiment, is a multifunctional protective case for tablets and similar devices, comprising a protective housing configured to enclose and protect a tablet, a plurality of walls adhered to the edges of the tablet, wherein at least one of the walls includes a writing utensil holder designed for securely and removably accommodating a writing utensil, a back wall of the case has an outer surface that includes a writing surface in the form of a dry erase board or whiteboard, wherein the writing surface is designed for receiving markings from the writing utensil. A clear, removable cover overlays the writing surface, wherein the cover is adapted to protect the markings on the writing surface from being erased and is removable to provide access to the writing surface for writing or erasing purposes.

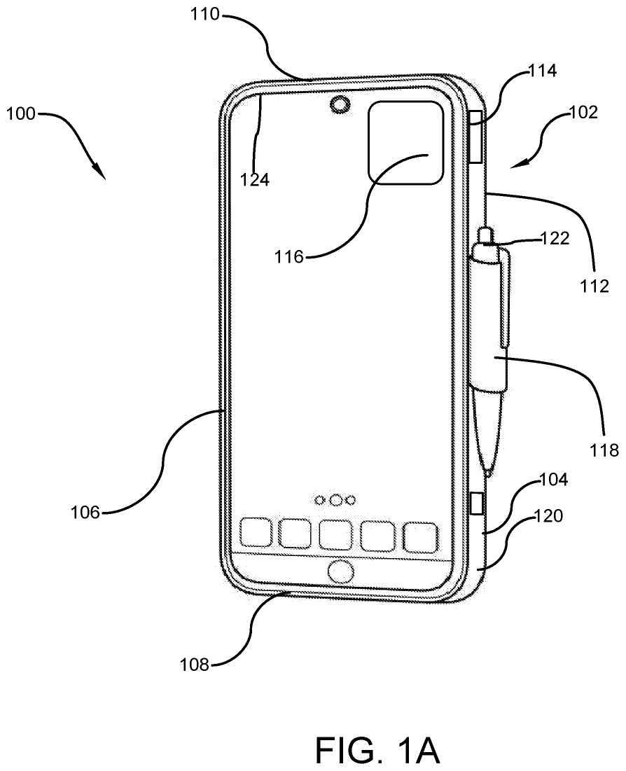

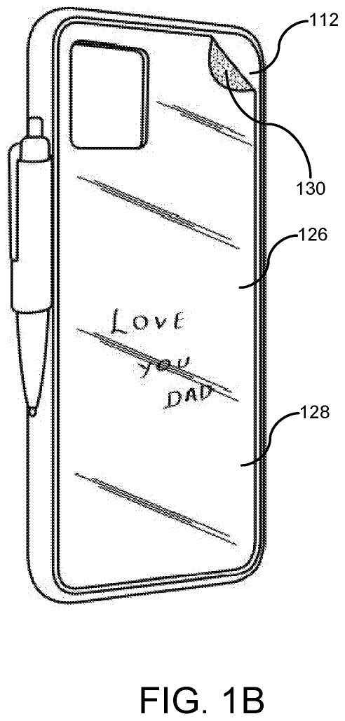

Referring initially to the drawings, FIG. 1A illustrates a front perspective view of one potential embodiment of the multifunctional electronic device case of the present invention in accordance with the disclosed structure. The multifunctional electronic device case 100 includes a protective housing 102 designed to coupling and enclosing at least a portion of a mobile phone. The housing 102 includes a pair of side walls 104, 106, a bottom wall 108, and a top wall 110 to secure a mobile phone. The walls extend perpendicularly (i.e., orthogonally) from a planar rear surface 112 of the protective housing 102. One or more walls of the housing 102 includes one or more slots 114 disposed therein for enabling access of charging ports and more of a mobile phone when the case 100 encloses the mobile phone.

When the mobile phone is enclosed in the case 100, the back of the mobile phone abuts the rear surface 112 of the housing 102. The walls secure the mobile phone and prevent unintentional disengagement and removal of the mobile phone. The planar back surface 112 can include a cut-out 116 for accommodating and enabling access of rear cameras of the mobile phone. Depending on the design of the mobile phone, one or more cut-outs can be disposed at different positions on the planar back surface 112.

One of the side walls 104, 106 includes a cylindrical loop 118 on the outer surface 120 thereof for accommodating a writing tool 122 such as a dry-tip marker. The writing tool 122 does not disengage unintentionally from the cylindrical loop 118 and the loop 118 secures the tool 122 using friction fit. The writing tool 122 is removed from the cylindrical loop 118 by applying a sufficient force to overcome the friction fit. The protective housing 102 is sized such that the surfaces of the cell phone fit snug with the inside surfaces 124 of the protective case element when the phone is inside the protective housing 102. Further, the cylindrical loop 118 does not obstruct the enclosure of the cell phone inside the protective housing 102. The cylindrical loop 118 can be integral with the protective housing 102 or in other embodiments can also be attached to the protective housing 102, using fasteners, glue, snapping features, and more.

The phone case 100 can be made from a resilient material that can have a combination of durability, shock absorption, and scratch resistance. Preferably, the case 100 can be made of one or more polycarbonate, thermoplastic polyurethane, silicon, leather, carbon fiber, Kevlar, rubber, or a metal. Further, the material is heat resistant and waterproof.

FIG. 1B illustrates a rear perspective view of the multifunctional electronic device case of FIG. 1A in accordance with the disclosed structure. The planar back surface 112 of the case 100 includes a dry erase board liner or a whiteboard liner (i.e., writing surface) 126 adhered thereon. The dry erase board or whiteboard liner or writing surface 126 has substantially the same size and shape as the planar back surface 112, including a cut-out corresponding to cut-out 116. In some embodiments, the dry erase board liner or whiteboard liner 126 covers a portion of the planar back surface 112. The dry erase board liner 126 can be integral with the planar back surface 112 or in other embodiments can also be selectively attached to the planar back surface 112, using fasteners such as glue, adhesive, snapping features, and more.

The dry erase board or whiteboard liner or writing surface 126 is used for making notes, doodles, drawings, and more using the writing tool 122, thereby eliminating the requirement of physical paper. A clear cover 128 overlaps the dry erase board or whiteboard writing surface 126 for preventing the notes, doodles, drawings, and more from becoming accidentally or unintentionally erased. The clear cover 128 can be secured using fasteners 130, along at least one edge, which can be hinges, snap buttons, and more. In some embodiments, the clear cover 128 can be slid along the side walls 104, 106 to removably overlap the dry erase board or whiteboard liner or writing surface 126. It is to be appreciated that the clear cover 128 selectively hinges to cover and uncover the writing surface 126 for protecting notes written on the writing surface 126. When uncovered, the writing surface can be wiped or erased to clear the writing surface 126 for reuse.

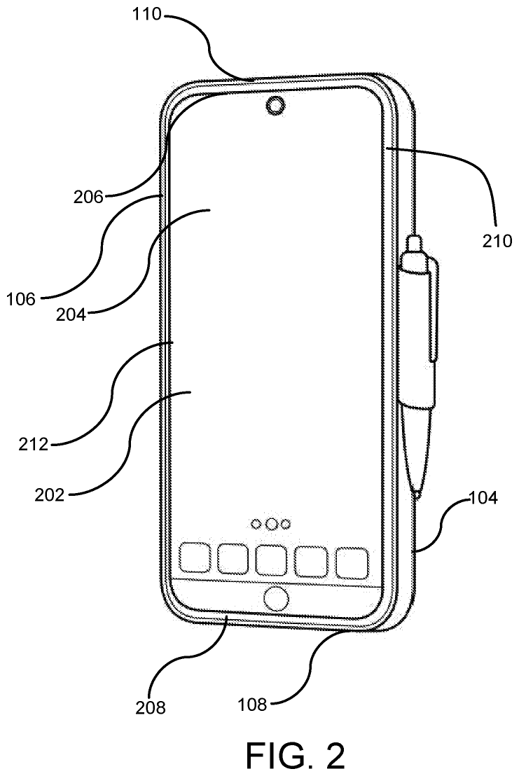

FIG. 2 illustrates a mobile phone enclosed in the multifunctional phone case of FIGS. 1A and 1B in accordance with one embodiment of the present invention. As illustrated, a mobile phone 202 is enclosed and secured by the mobile phone case 100. The touchscreen 204 is accessible and in some embodiments, the case 100 may include a touch sensitive transparent cover for protecting the touchscreen 204. The top wall 110 adheres to the top edge 206, the bottom wall 108 adheres to the bottom edge 208 and the side walls 104, 106 adheres to the side edges 210, 212 of the mobile phone 202.

The dry erase board or whiteboard writing surface 126 is used for writing, making notes, doodling, and more using the writing tool 122. The clear cover 128 protects the notes from erasing accidentally. The cover 128 can be selectively removed or displaced to clean the dry erase board or whiteboard 126 for reuse.

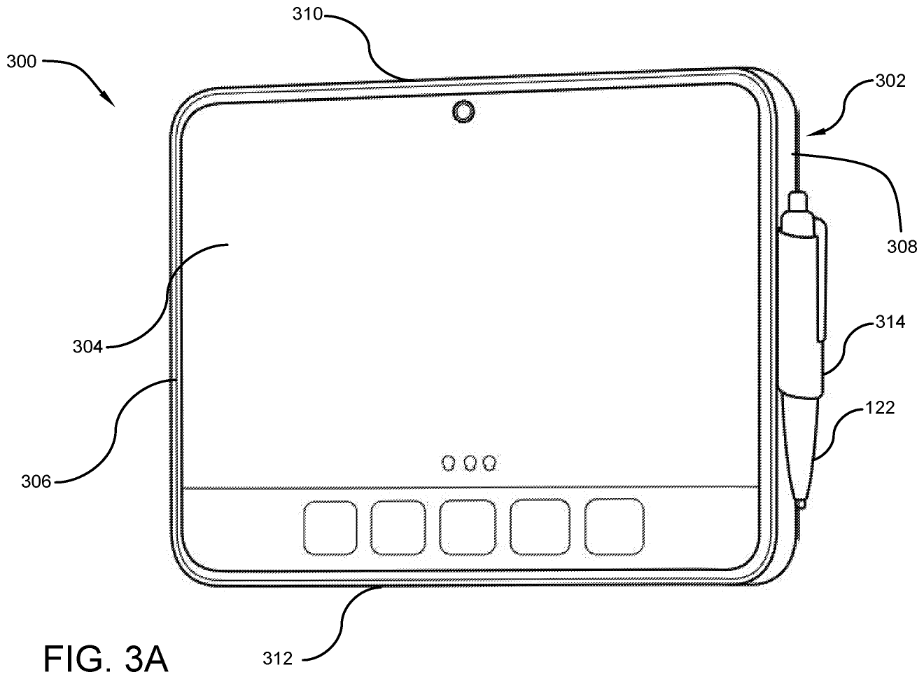

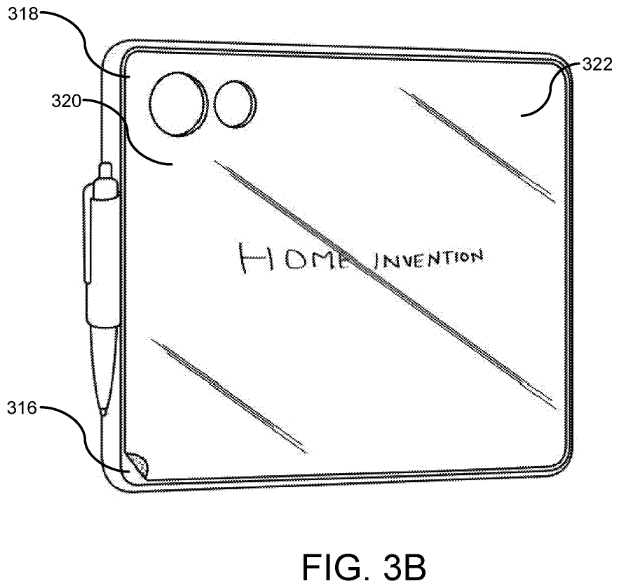

FIG. 3A illustrates a front perspective view of a tablet phone case of the present invention in accordance with the disclosed structure. In the present embodiment, the multifunctional protective case 300 is designed for electronic tablets and other similar electronic devices. The case 300 includes a protective housing 302 for enclosing and protecting a tablet 304. The walls 306, 308, 310, 312 adhere to the edges of the tablet 304 and one of the walls include a cylindrical loop 314 for securely and removably accommodating the writing utensil 122.

As illustrated in 3B, the outer surface 318 of the back wall 316 of the case 300 includes a writing surface 320 in the form of a dry erase board or whiteboard. For making notes, doodles, and more, the writing utensil 122 can be removed from the cylindrical loop 314 and used for writing on the writing surface 320. A clear cover 322 protects the notes and more from becoming erased and the cover 322 can be removed for accessing the writing surface 320.

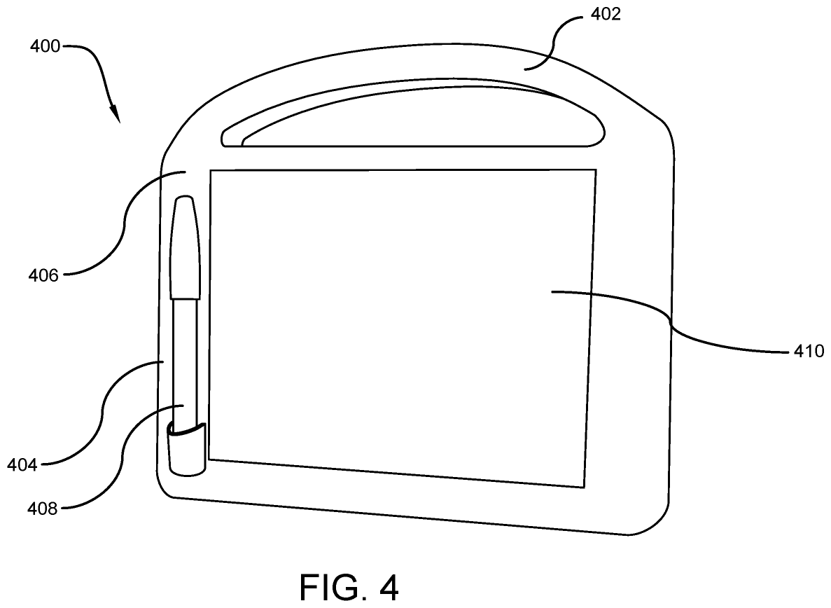

FIG. 4 illustrates a rear view of yet another embodiment of the multipurpose protective case of the present invention in accordance with one embodiment of the present invention. In the present invention, the table protective case 400 includes an integrated handle 402 for carrying the tablet enclosed in the case 400. A writing utensil holder 404 is included in the rear surface 406 for holding a writing utensil 408. The whiteboard 410 is embedded in the rear surface 406 and is used for writing, making notes, and more.

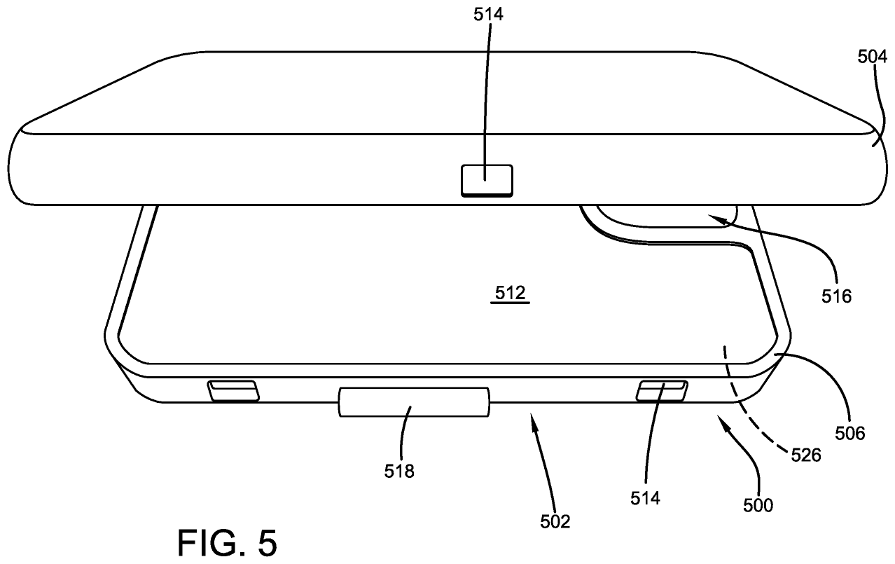

FIG. 5 illustrates a front perspective view of another embodiment of the multifunctional electronic device case of the present invention in accordance with the disclosed structure. The multifunctional electronic device case 500 includes a protective housing 502 designed for coupling and enclosing at least a portion of a mobile phone. The housing 502 includes a cover 504 and a base 506 to secure a mobile phone and other contents therein (i.e., ID, credit card, cash). The cover 504 is hingedly connected to the base 506 and creates a cavity for the mobile phone and other contents. The cover 504 rotates around to the rear of the base 506 and functions as a stand to prop up the mobile phone. One or more walls of the cover 504 and base 506 includes one or more slots 514 disposed therein for enabling access of charging ports and more of a mobile phone when the case 500 encloses the mobile phone.

When the mobile phone is enclosed in the case 500, the back of the mobile phone abuts the rear surface 512 of the housing 502. The walls secure the mobile phone and prevent unintentional disengagement and removal of the mobile phone. The planar back surface 512 can include a cut-out 516 for accommodating and enabling access of rear cameras of the mobile phone. The hinged cover 504 swings around to the back of the base 506 and acts as a stand for the housing 502.

One of the side walls of the cover 504 or base 506 include a cylindrical loop 518 on the outer surface thereof for accommodating a writing tool such as a dry-tip marker. The protective housing 502 is sized such that the surfaces of the cell phone fit snug with the inside surfaces of the protective case element when the phone is inside the protective housing 502. Further, the cylindrical loop 518 does not obstruct the enclosure of the cell phone inside the protective housing 502. The cylindrical loop 518 can be integral with the protective housing 502 or in other embodiments can also be attached to the protective housing 502, using fasteners, glue, snapping features, and more.

The phone case 500 can be made from a resilient material that can have a combination of durability, shock absorption, and scratch resistance. Preferably, the case 500 can be made of one or more polycarbonate, thermoplastic polyurethane, silicon, leather, carbon fiber, Kevlar, rubber, or a metal. Further, the material is heat resistant and waterproof.

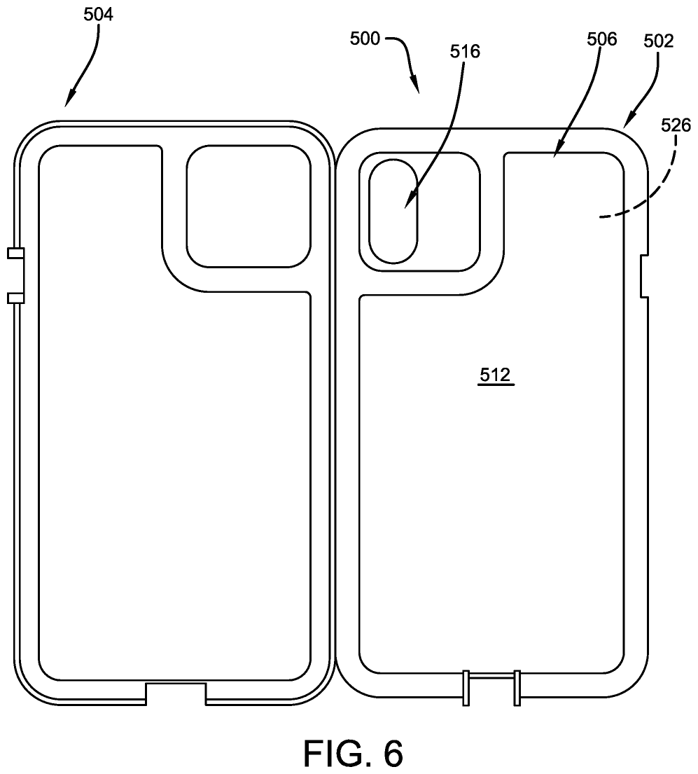

FIG. 6 illustrates another view of the multifunctional electronic device case of FIG. 5 in accordance with the disclosed structure. The planar back surface 512 of the base 506 includes a dry erase board liner or a whiteboard liner (i.e., writing surface) 526 adhered thereon. The dry erase board or whiteboard liner or writing surface 526 has substantially the same size and shape as the planar back surface 512, including a cut-out corresponding to cut-out 516. In some embodiments, the dry erase board liner or whiteboard liner 526 covers a portion of the planar back surface 512. The dry erase board liner 526 can be integral with the planar back surface 512 or in other embodiments can also be selectively attached to the planar back surface 512, using fasteners such as glue, adhesive, snapping features, and more.

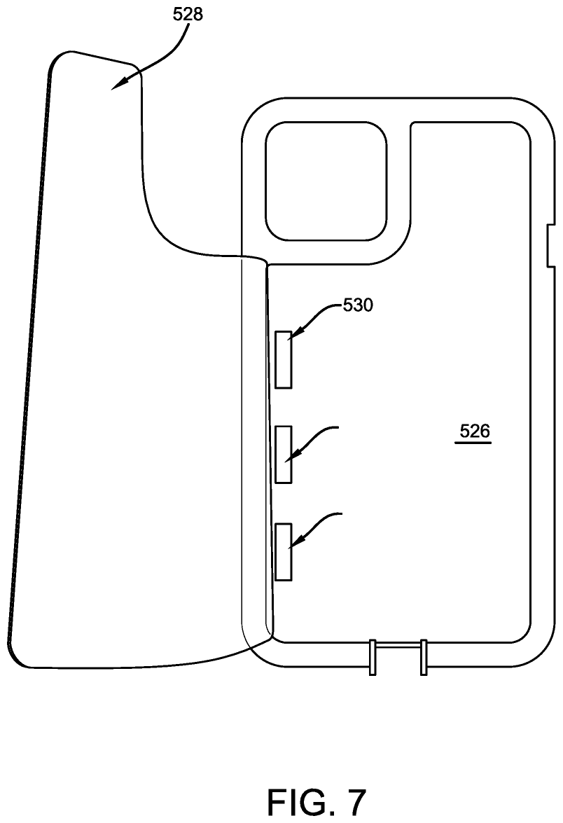

Referring to FIG. 7, the dry erase board or whiteboard liner or writing surface 526 is used for making notes, doodles, drawings, and more using the writing tool 122, thereby eliminating the requirement of physical paper. A clear cover 528 overlaps the dry erase board or whiteboard writing surface 526 for preventing the notes, doodles, drawings, and more from becoming accidentally or unintentionally erased. The clear cover 528 can be secured using fasteners 530, along at least one edge, which can be hinges, snap buttons, and more. It is to be appreciated that the clear cover 528 selectively hinges to cover and uncover the writing surface 526 for protecting notes written on the writing surface 526. When uncovered, the writing surface can be wiped or erased to clear the writing surface 526 for reuse.

The dry erase board or whiteboard writing surface 526 is used for writing, making notes, doodling, and more using the writing tool 122. The clear cover 528 protects the notes from erasing accidentally. The cover 528 can be selectively removed or displaced to clean the dry erase board or whiteboard 526 for reuse.

In some embodiments of the present invention, the whiteboard or dry ink board can be an LCD display which is erasable and can be pressure sensitive. Any conventional writing utensil can be used for writing on the whiteboard and displays the liquid crystals for writing. The written material can be erased to reorient the liquid crystals.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “multifunctional electronic device case”, “dual function case”, “mobile phone case”, “tablet case”, and “case” are interchangeable and refer to the combination mobile phone case and writing surface 100, 300, 400, 500 of the present invention.

Notwithstanding the foregoing, the combination mobile phone case and writing surface 100, 300, 400, 500 of the present invention can be of any suitable size and configuration as is known in the art without affecting the overall concept of the invention, provided that it accomplishes the above-stated objectives. One of ordinary skill in the art will appreciate that the combination mobile phone case and writing surface 100, 300, 400, 500 as shown in the FIGS. is for illustrative purposes only, and that many other sizes and shapes of the combination mobile phone case and writing surface 100, 300, 400, 500 are well within the scope of the present disclosure. Although the dimensions of the combination mobile phone case and writing surface 100, 300, 400, 500 are important design parameters for user convenience, the combination mobile phone case and writing surface 100, 300, 400, 500 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An electronic device case comprising:
a protective housing having a planar rear surface;
a pair of side walls;
a bottom wall;
a top wall;
wherein said pair of side walls, said bottom wall, and said top wall extend orthogonally from said planar rear surface for enclosing at least a portion of an electronic device;
wherein at least one of said pair of side walls having a slot extending therethrough for enabling access of a charging port of said electronic device;
wherein a back area of said electronic device abutting said planar rear surface of said protective housing;
wherein at least one of said pair of side walls on an outer surface having a loop for securing a writing tool therethrough; and
further wherein said planar rear surface having an exterior liner including a dry erase board writing surface.

2. The electronic device case of claim 1, wherein said exterior liner having a clear cover for selectively shielding said dry erase board writing surface.

3. The electronic device case of claim 2, wherein said electronic device is a mobile phone.

4. The electronic device case of claim 3, wherein said planar rear surface having at least one cut-out for enabling a view for a rear camera lens of said mobile phone.

5. The electronic device case of claim 2, wherein said writing tool is a dry-tip marker.

6. The electronic device case of claim 2, wherein said writing tool friction fit through said cylindrical loop.

7. The electronic device case of claim 5, wherein said protective housing having a material selected from the group consisting of a polycarbonate, a thermoplastic polyurethane, a silicon, a leather, a carbon fiber, a Kevlar, a rubber, and a metal.

8. The electronic device case of claim 5, wherein said exterior liner selectively attached to said planar rear surface.

9. An electronic device case comprising:
a protective housing having a planar rear surface;
a pair of side walls;
a bottom wall;
a top wall;
wherein said pair of side walls, said bottom wall, and said top wall extend orthogonally from said planar rear surface for enclosing at least a portion of an electronic device;
wherein a back area of said electronic device abutting said planar rear surface of said protective housing;
wherein at least one of said pair of side walls on an outer surface having a loop for securing a writing tool therethrough; and
further wherein said planar rear surface having an exterior liner including a whiteboard writing surface.

10. The electronic device case of claim 9, wherein said exterior liner having a clear cover for selectively shielding said whiteboard writing surface.

11. The electronic device case of claim 10, wherein said electronic device is a mobile phone.

12. The electronic device case of claim 11, wherein said planar rear surface having at least one cut-out for enabling a view for a rear camera lens of said mobile phone.

13. The electronic device case of claim 12, wherein said writing tool is a dry-tip marker.

14. The electronic device case of claim 13, wherein said writing tool friction fit through said cylindrical loop.

15. The electronic device case of claim 14, wherein said protective housing having a material selected from the group consisting of a polycarbonate, a thermoplastic polyurethane, a silicon, a leather, a carbon fiber, a Kevlar, a rubber, and a metal.

16. The electronic device case of claim 10, wherein said exterior liner selectively attached to said planar rear surface.

17. An electronic device case comprising:
a protective housing having a cover and a base with a rear surface;
a pair of side walls;
a bottom wall;
a top wall;
wherein said pair of side walls, said bottom wall, and said top wall extend orthogonally from said rear surface for enclosing at least a portion of an electronic device;
wherein a back area of said electronic device abutting said rear surface of said protective housing;
wherein at least one of said pair of side walls on an outer surface having a loop for securing a writing tool therethrough;
wherein said rear surface having an exterior liner including a material selected from the group consisting of a dry erase board writing surface and a whiteboard writing surface;
wherein said exterior liner having a clear cover for selectively shielding of said exterior liner;
wherein said rear surface having a first cut-out for enabling a view for a rear camera lens of said electronic device; and
further wherein said exterior liner having a second cut-out aligned with said first cut-out.

18. The electronic device case of claim 17, wherein said cover hingedly connected to said base; and
further wherein said cover hinges around to a rear of said base to prop up said protective housing.

19. The electronic device case of claim 17, wherein said writing tool is a dry-tip marker.

20. The electronic device case of claim 17, wherein said exterior liner selectively attached to said rear surface.
